(19) United States
(12) Patent Application Publication
(10) Pub. No.: US 2009/0169239 A1
(43) Pub. Date: Jul. 2, 2009

(54) Cleaner Blade Lubrication for a Printer Belt Component

(76) Inventors: Paul Wesley Etter, Lexington, KY (US); Whitney April Greer, Lexington, KY (US); David Starling MacMillan, Winchester, KY (US); Edward A. Rush, Richmond, KY (US); Peter B. Pickett, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/344,420

(22) Filed: Dec. 26, 2008

Related U.S. Application Data
(60) Provisional application No. 61/017,433, filed on Dec. 28, 2007.

(51) Int. Cl. G03G 15/16

(52) U.S. Cl. 399/101

(57) ABSTRACT

The present disclosure relates to a method and apparatus for removing contaminants from a belt in a printer. A blade is provided that contacts with the belt surface to form a nip where the belt is configured to either receive an image for transfer to a sheet of media or transport media within the printer for receipt of toner images. The blade surface is coated with a fluoropolymer resin in combination with a polymeric binder. The coated blade/belt provides a reduced coefficient of friction at the nip to reduce belt stall and/or belt flipping, which may lock the blade to the belt and prevent further printer operation. The coated blade/belt herein is particularly useful when applied to printing operations that utilize chemically processed toner.

### CROSS REFERENCES TO RELATED APPLICATIONS

The present application claims the benefit of the filing date of U.S. Provisional Application Ser. No. 61/017,433 filed Dec. 28, 2007, the teachings of which are incorporated herein by reference.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to a lubricant for a cleaning blade that may be used to clean image forming material such as toner or any other contaminants from a belt surface during a printing operation.

2. Description of the Related Art

During the image forming process, image forming material, such as toner, may be transferred from toner carrying members to print or copy media. Inefficiencies in the transfer process may cause residual toner to remain on the toner carrying members or other transport members, such as transport belts, intermediate transfer belts/drums, and photoconductive members. Residual toner may also be created during registration, color calibration, paper jams, and over-print situations. The toner carrying members and/or other transport member may also become contaminated with paper dust and/or other debris during normal operation. If left on the toner carrying members and/or other transport member, the residual toner and/or other debris may influence the quality of subsequent images. The residual or waste toner and/or other debris may be removed by a blade or other means and the removed toner can be stored in a waste toner housing.

### SUMMARY OF THE INVENTION

In a first exemplary embodiment, the present disclosure relates to a method for removing contaminants from a belt in an electrophotographic printer. The method includes providing a blade having a surface for contact with the belt surface and forming a nip having a first coefficient of friction (COF₁). The belt surface may then be configured to (a) receive a toner image for transfer to a sheet of media; or (b) transport media within the printer for receipt of a toner image. This may then be followed by applying a lubricant to the blade surface and forming a coating, the lubricant comprising a fluoropolymer resin in combination with a polymeric resin. The coating may have a thickness of 1-30 microns, wherein the coated blade surface forms a nip with the belt surface providing a second coefficient of friction (COF₂), wherein COF₂<COF₁.

In a second exemplary embodiment, the present disclosure relates to a printer including a belt having a surface, comprising a blade having a surface configured to contact with the belt surface to form a nip. The nip then defines a first coefficient of friction (COF₁) as between the blade surface and the belt wherein the belt surface is configured to: (a) receive a toner image for transfer to a sheet of media; or (b) transport media within the printer for receipt of a toner image. The blade surface includes a coating, wherein the coating contains a fluoropolymer resin in combination with a polymeric binder. The coating has a thickness of 1-30 microns, wherein the coated blade surface also may form a nip with the belt surface and provide a second coefficient of friction (COF₂), wherein COF₂<COF₁.

In a third exemplary embodiment, the present disclosure relates to a printer including a belt having a surface, comprising a blade having a surface configured to contact with the belt surface to again form a nip. The nip defines a first coefficient of friction (COF₁) as between said blade surface and the belt wherein the belt surface is configured to: (a) receive a toner image for transfer to a sheet of media; or (b) transport media within the printer for receipt of a toner image. The blade surface includes a coating, the coating comprising a fluoropolymer resin in combination with a polymeric binder, where the coating has a thickness of 1-30 microns. The coated blade surface then forms a nip with the belt surface and provides a second coefficient of friction (COF₂), wherein the percent reduction of COF₁ relative to COF₂ is at least 50% and wherein the toner image that is received on the belt or received on the media comprises toner prepared by chemical methods

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an example of an electrophotographic type printer that utilizes an intermediate transfer mechanism (ITM);

FIG. 2 illustrates an example of an electrophotographic printer that utilizes a transport belt module (TBM); and

FIG. 3 illustrates an example of the toner cleaner apparatus including a cleaning blade that may be used in either the ITM or TBM printers noted above.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the present disclosure may be implemented in software. As such, it should be noted that a plurality of hardware and software-based devices, as well as a plurality of different structural components may be utilized to implement the present disclosure. Furthermore, and as described in subsequent paragraphs, the specific mechanical configurations illustrated in the drawings are intended to exemplify embodiments of the present disclosure and that other mechanical configurations are possible.

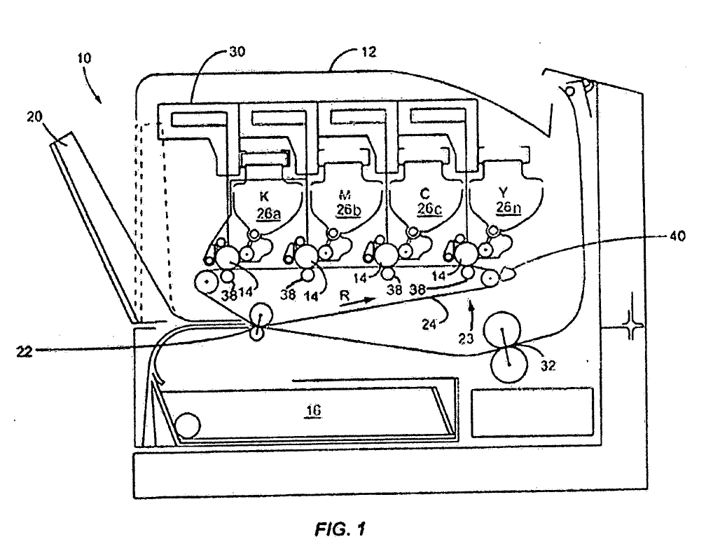

According to one embodiment, the present disclosure may be directed to a cleaner apparatus for cleaning a belt component within an image forming device. FIG. 1 depicts one embodiment of a representative image forming device, indicated generally by the numeral 10. The image forming device 10 may comprise a main media sheet stack 16 and/or a manual input 20. The term “image forming device” and the like is used generally herein as a device that produces images on a media sheet. Examples include, but are not limited to, a laser printer, ink-jet printer, fax machine, copier, and a multi-functional machine. Examples of an image forming device include Model Nos. C750 and C752 available from Lexmark International, Inc. of Lexington, Ky.

Within the image forming apparatus body 12, the image forming apparatus 10 may include one or a plurality of removable image formation cartridges 26a-26n. In one embodiment, for color printing, the apparatus 10 may include a black cartridge (K), a magenta cartridge (M), a cyan cartridge (C), and a yellow cartridge (Y). Accordingly, each cartridge 26a-26n may form an individual single color image that may be combined in layered fashion with images from the other cartridges to create the final multi-colored image. The image forming apparatus may further include an intermediate transfer mechanism (ITM) 23, one or more imaging devices 30, a fuser 32, and a waste toner cleaner 40 as well as various rollers, actuators, sensors, optics, and electronics (not shown) as are conventionally known in the image forming apparatus arts.

The internal components of removable image formation cartridges 26a-26n are not specifically identified in FIG. 1, but are briefly described. Each image formation cartridge 26a-26n may include a removable cartridge that may include a reservoir holding a supply of toner, a developer roller for applying toner to develop a latent image on a photoconductive drum, and a photoconductive (PC) drum 14, which may comprise, for example, an aluminum hollow-core drum coated with one or more layers of light-sensitive organic photoconductive materials. The image formation cartridge 26a-26n may additionally include various rollers, paddles, augers and blades. Note that this description is representative only and various image formation devices may organize these components into a plurality of cartridges.

Upon command from control electronics, a single media sheet may be “picked,” or selected, from either the primary media stack 16 or the manual input 20. Regardless of its source, the media sheet may be transported to transfer location 22 to receive a toner image from the ITM 23. The ITM 23 may include one or more ITM belts 24, for example, an endless belt that rotates in the direction indicated by arrow R around a series of rollers adjacent to the PC drums 14 of the respective image formation cartridges 26. Toner may be deposited from each PC drum 14 as needed to create an image on the ITM belt 24. The ITM belt 24 and each PC drum 14 may be synchronized so that the toner from each PC drum 14 precisely aligns on the ITM belt 24 during a single pass.

The media sheet may receive an electrostatic charge before contacting the ITM belt 24 at the transfer location 22 to assist in attracting the toner from the belt 24. The sheet and attached toner may travel through a fuser 32 having a pair of rollers and a heating element that heats and fuses the toner to the sheet. The paper with a fused image may then be transported out of the printer body 12 for receipt by a user.

In the image forming apparatus 10 shown in FIG. 1, four image formation cartridges 26a-26n are arrayed along the ITM belt 24. A full color image may be formed on the ITM belt 24 and the color image may be subsequently transferred to a print media sheet at a secondary transfer location 22. Accordingly, the intermediate transfer mechanism (ITM) may be understood herein as a system where image forming material (toner) is imaged to a belt surface and toner that does not go to the media page may be cleaned by a cleaning blade forming a nip (contact region) with the belt within cleaner component 40, discussed more fully below.

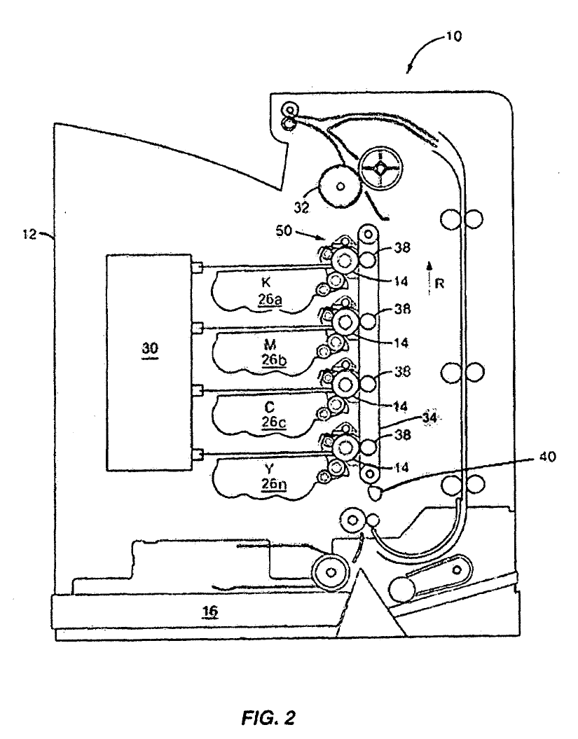

In other image forming devices, print media sheets may be transported by what may be described as a transport belt module (TBM) 50. One such example of an image forming apparatus 10 including a TBM 50 is next illustrated in FIG. 2. According to this embodiment, a full color image may be formed directly on the media sheet by successively transferring images from the four respective image formation cartridges 26a-26n (e.g., cyan, yellow, magenta, and optionally black) onto the media sheet. The TBM 50 may include one or more belts 34 configured to support and/or transport the media sheets within the printer, e.g. past the plurality of imaging forming units 26a-26n. As may be appreciated, in the TBM system, there is relatively less opportunity for toner to be placed on belt 34 as the transfer is more direct to the media (e.g. paper). However, even in a TBM system, toner may collect on the belt during start-up and/or shutdown routines, as well as at an interpage gap. Accordingly, the TBM system may also include a toner cleaner component 40 that similarly provides a cleaning blade forming a nip (contact region) with the belt 34.

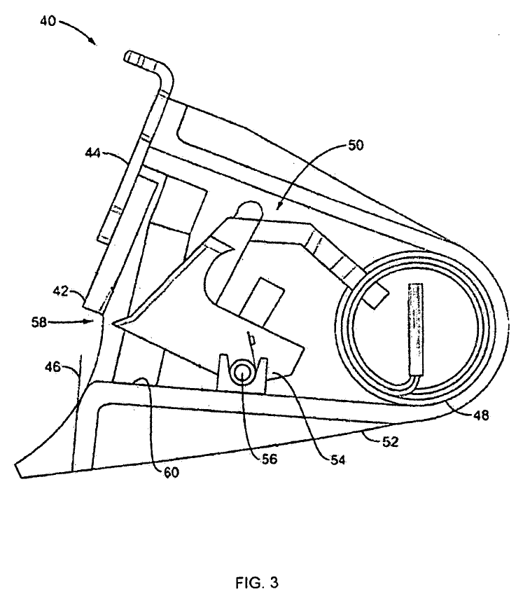

Turning now to FIG. 3, a side cross-sectional view of one example of the toner cleaner 40 is shown. As alluded to above, the toner cleaner 40 may comprise a blade 42, blade bracket 44, lower seal 46, auger 48, and cleaner apparatus 50 which may all contained within or coupled to a housing 52. The waste toner cleaner 40 may be positioned so that at least a portion of the cleaner blade 42 is in contact with a surface (e.g. belts 24 and/or 34 noted above) to be cleaned.

In the orientation shown in FIG. 3, the surface to be cleaned may move past the waste toner cleaner 40 at the inlet to the housing 58. As the surface of, e.g. the belts 24 and/or 34 to be cleaned move past the waste toner cleaner 40, the cleaner blade 42 may form a nip with the belt and remove toner from that surface. The removed toner may be guided at inlet 58 into the interior of the housing 52 by lower seal 46. The removed toner may accumulate in the housing on floor 60, which may be sloped gradually downward and rearward away from the inlet 58. The auger 48 may rotate to transport the waste toner to a separate part of housing 52 or to a remote storage container (not shown). While the auger 48 is depicted as a coiled wire, other conveyors known to those skilled in the art, including screws or other equivalent devices, may be used. The cleaner apparatus 50 may comprise a toner moving member 54 that may be pivotally attached to the housing 52, for example, at pivot point 56, and may be configured to move waste toner and/or debris away from the blade 42 and/or inlet 58. One example of a cleaner apparatus and toner moving member 54 is described in U.S. Pat. No. 7,043,189, which is incorporated fully herein by reference.

As mentioned above, the cleaner blade 42 may form a nip with the surface of a belt. The belts that may be used may be sourced from polymeric type materials, such as poly(vinylidine fluoride), polyimides, polyamides, polyesters, polycarbonate, thermoplastic elastomers (e.g., polyurethane or polyester type thermoplastic elastomers), as well as certain fluoropolymer resins such as ethylene-tetrafluoroethylene (ETFE). Polyimide type polymeric materials may be further understood as those resins containing one or more imide type units within the repeating unit of a polymer chain, examples of which are provided below:

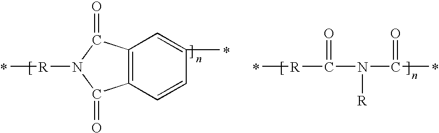

wherein R may be an aliphatic (e.g. —CH₂—) or aromatic (e.g. benzene) type group and n may have a value to provide a number average molecular weight of 10,000-500,000. Accordingly, polyimides may include aromatic polyimides, aliphatic type polyimides, and/or aliphatic-aromatic type polyimides, which polymers may serve as the belt material for the ITM and/or TBM system noted herein. The polyimide type materials may therefore provide relatively high tensile strength (e.g. greater than or equal to 10,000 psi), avoid creep (strain versus time for a given load), relatively high modulus (e.g. greater than or equal to 300,000 psi) as well as relatively high heat resistance (Tg or glass transition temperature of greater than or equal to 400° C.), within a given electrophotographic printer environment.

The cleaning blade itself may be formed from a polymer material, including, for example, a polyolefin type material, a polyamide, a polyester, or a polyamide (Nylon). In particular, the cleaning blade may be formed from a polyurethane type material, which may be understood as a polymer resin containing urethane type repeating unit structure such as:

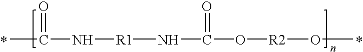

In the above, it may be appreciated that R1 and R2 may again be selected from either aliphatic —(CH₂)—, substituted aliphatic —(CHR₃)— and/or aromatic type functionality. In addition, R₃ may itself be selected from a carbon atom and/or an aromatic type functional group. Finally, it should also be appreciated that the polyurethane may contain what are termed “soft segments”, i.e., urethane type repeating structure formed due to the reaction of a diisocyanate with a polyol, e.g., a hydroxy-terminated polyether type compound and/or hydroxy-terminated polyester type compound with a molecular weight of 500-5000.

It may therefore now be appreciated that with respect to the above belt type materials, one may define either a static and or dynamic coefficient of friction (COF) value as between the belt surface and the surface of the cleaner blade at the cleaning nip location. Such COF values may therefore become sufficiently high to provide continuous adequate cleaning of the belt surface. However, as may be appreciated, on balance, relatively high friction at the cleaning nip location may ultimately lead to the problem where the belt may stall during a given printing operation which may therefore render the printer non-functional. In addition, relatively high friction may lead to heat build-up and unwanted softening and filming of the toner. Furthermore, it has been observed that belt stall may be more prone to occur when the printer is in a relatively new and unused condition. Moreover, under certain situations, if a relatively small portion of the blade is not sufficiently lubricated a portion of the blade may undergo flipping, due to a spike (relatively large increase) in cleaner nip friction at such location. Flipping of the blade may be understood as that situation where the blade assumes a configuration that mechanically locks the belt, which again, may prevent further operation of the printer.

Conventionally, in order to control the above referenced problems, it has been one practice to initially provide lubrication to the blade by applying, e.g., toner and/or corn starch. However, as may be appreciated, toner and/or corn starch is likely to have a temporary effect, and during operation of the printer, such lubrication is likely to be flushed from the cleaning nip location. Under these conditions, friction between the blade and belt will increase and as noted above, this may lead to belt stall, unwanted heat build-up, etc.

In addition, it is worth noting that with respect to the belt surfaces in either an ITM or TBM system, a number of such surfaces are currently reported as being cleaned with brushes as opposed to blades in order to avoid the above referenced problems of belt stall and flipping. In addition, a number of ITM or TBM systems are understood to be cleanerless (e.g. no provisions to remove contaminants). Accordingly, the disclosure herein of a blade/belt cleaning system that can be lubricated to provide relative permanent lubrication, lowered COF values, which reduces or avoids stalling and/or flipping, and as specifically applied to particular types of toner compositions (see below), is believed to provide an unexpected advantage as well as improved printer performance with respect to the lubricant/blade combinations contemplated for ITM and/or TBM based printers.

The lubricant that may be utilized herein may be applied to blade by a liquid coating application, such as dipping, spraying, flow coating or brushing. The thickness of the coating once formed on the blade surface may be up to about 40 microns, including all values and increments between 1-30 microns. For example, the coating may specifically have a thickness of 5-20 microns. One particular useful range is about 5-10 microns. It may be appreciated that such identified thickness levels may optimize printer performance, while also not utilizing more lubricant that may be necessary for lubrication as between the blade and the belt surface.

Furthermore, the lubricant, when applied, may rely upon an organic or aqueous based solvent system (e.g. an organic alcohol) along with the presence of a fluoropolymer resin. The fluoropolymer resin may include, e.g., those polymers that contain a C—F bond, such as poly(tetrafluoroethylene) or PTFE. Other fluoropolymers contemplated herein include ethylene-tetrafluoroethylene (ETFE), poly(chlorotrifluroethylene) (PCTFE), perfluroalkoxytetraflurothylene (PFATFE), etc.

In addition, a second polymer component may be present, which second component may serve as a binder for the fluoropolymer and secure the fluoropolymer to the cleaning blade surface. The second polymer may also provide charge dissipation to charged toner on the belt surface. That is, when toner is electrostatically charged, electrostatic attraction of the toner to the belt may reduce the effectiveness of the cleaning blade. Accordingly, any charge dissipation provided by the second polymer component may neutralize toner charge (e.g. convert negatively or positively charged toner to neutral toner) and therefore improve belt cleaning. The second polymer binder component may therefore include a polyamine type polymer of the following general structure:

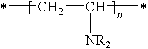

where R may be an aliphatic, cycloaliphatic, substituted aliphatic and/or aromatic type functionality. In addition, the polyamide may be provided as a charged polymer configuration (e.g. wherein the pendant nitrogen atom is further substitute to provide a net positive charge). In addition, the polyamines may include poly(vinyl pyrrolidone) having the following general structure:

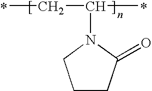

Preferably, the level of solvent (aqueous or organic) may be about 40-90% by weight. The fluoropolymer may be present at a level of about 10-60% by weight. The binder resin may be present at levels of about 0.5% to about 5.0% by weight. In addition, the lubricant composition may contain another component, such as a slip agent, at a concentration of 0.1-1.0% by weight. A slip agent may be understood as another ingredient which further reduces the friction that may be developed as between the blade and belt at the nip location. One exemplary slip agent may include a fatty-acid amide such as N-stearyl erucamide. Fatty acid amides may be understood herein as amide compounds formed from a fatty acid, which is an aliphatic carboxylic acid, saturated or unsaturated, having up to about 30 carbon atoms. For example, fatty acid amides contemplated herein may also include oleamides and/or stearamides. Slip agents may also include a polyether-modified dimethylpolysiloxane copolymer, such as BYK®-341 available from Byk Chemie, Wallingford, Conn. Furthermore, one exemplary lubricant that may be used herein is a product known as Liquid Surelube 2SA™, available from Optical Technologies Corporation.

In particular, the application of the above referenced coating to cleaning blades used in either an ITM or TBM module may be particularly advantageous, and avoid the indicated problems of belt stall and/or flipping (mechanical locking) when applied to toner particles that are prepared by chemical methods, and in particular via an emulsion aggregation procedure, which generally provides resin, colorant and other additives. A chemical method herein may be understood as a method that provides a given toner particle size without the need for mechanical pulverization. More specifically, the toner particles may be prepared via the steps of initially preparing a polymer latex from unsaturated olefin type monomers, in the presence of an ionic type surfactant, such as an anionic surfactant having terminal carboxylate (—COO⁻) functionality. The polymer latex so formed may be prepared at a desired molecular weight distribution (MWD=Mw/Mn) and may, e.g., contain both relatively low and relatively high molecular weight fractions to thereby provide a relatively bimodal distribution of molecular weights. Pigments may then be milled in water along with a surfactant that has the same ionic charge as that employed for the polymer latex. Release agent (e.g. a wax or mixture of waxes) may also be prepared in the presence of a surfactant that assumes the same ionic charge as the surfactant employed in the polymer latex. Optionally, one may include a charge control agent.

The polymer latex, pigment latex and wax latex may then be mixed and the pH adjusted to cause flocculation. For example, in the case of anionic surfactants, acid may be added to adjust pH to neutrality. Flocculation therefore may result in the formation of a gel where an aggregated mixture may be formed with particles of about 1-2 μm in size. Such mixture may then be heated to cause a drop in viscosity and the gel may collapse and relative loose (larger) aggregates, from about 1-25 μm, may be formed, including all values and ranges therein. For example, the aggregates may have a particle size between 3 μm to about 15 μm, or between about 5 μm to about 10 μm. In addition, the process may be configured such that at least about 80-99% of the particles fall within such size ranges, including all values and increments therein. Base may then be added to increase the pH and reionize the surfactant or one may add additional anionic surfactants. The temperature may then be raised to bring about coalescence of the particles, which then may be washed and dried. Coalescense is reference to fusion of all components.

Accordingly, a variety of resins are contemplated herein for use in a CPT toner that is then exposed to a cleaning blade with the above referenced coating, which blade is configured for cleaning the belt in either an ITM or TBM module. Accordingly, the resins may be sourced from monomers having ethylenically unsaturated bonds that may be subject to free radical polymerization. The resins may therefore include styrenes, acrylates, methacrylates, butadiene, isoprene, acrylic acid, methacrylic acid, acrylonitrile, vinyls, etc. Other resins may also be contemplated such as condensation polymers, including polyamide and/or polyester resins, of a linear, branched or even crosslinked configuration. The resins may also be modified such that they contain functional groups (e.g. an ionic group) which may allow the resin to more directly disperse in an aqueous medium without the need for surfactants.

A comparative analysis was conducted to evaluate the performance of the above noted coating, relative to the initial lubrication with toner, described above. In a printer configured generally according to FIG. 2 (i.e. a printer utilizing a transfer belt module or TBM) it was found that initial lubrication provided a torque of about 17 oz-in at the nip location between the blade and the belt. When the TBM underwent operation and consumed toner, which toner reached the nip location, the operating torque would fall in the range of about 8.0 to 15.0 oz-in. When lubricated with Surelube 2SA™ it was found that the operating torque would fall within the range of 8.0 to 15.0 oz-in and, as noted, provide lubrication over the life of the printer as compared to relying upon toner and/or cornstarch material.

In a still further comparative analysis of the influence of the lubricant, a number of belt materials were measured for their dynamic coefficient of friction without the presence of lubricant and compared to the dynamic coefficient of friction as between the blade and belt, when the blade was coated with Surelube 2SA™. The results are provided below in Table 1 below:

TABLE 1

| | | Average COF | Percent |
|---|---|---|---|
| | Average COF¹ | [Surelube | Reduction |
| Belt Material | [No Lubricant] | 2SA ™] | In COF |
| Poly(vinylidine | 3.7 | 0.75 | 80 |
| fluoride) | | | |
| Polyimide | >4.0 | 0.45 | 89 |
| Polyamide | 2.99 | 0.36 | 82 |
| Polycarbonate | >4.0 | 0.37 | 91 |
| Thermoplastic | 2.24 | 0.26 | 82 |
| Elastomer | | | |
| Ethylene | 0.82 | 0.31 | 62 |
| Tetrafluoroethylene | | | |
| Polymer | | | |

¹Average COF is the average dynamic coefficient of friction measured at the nip location as between a polyurethane type blade and surface of the indicated belt material.

As may therefore be observed from the above, the average coefficient of friction without lubricant (COF₁) at the nip location of the belt may be significantly reduced. In the context of the present disclosure such reduction is contemplated to be at least about 50%, and may fall in the range of 50-150%, including all values and increments therein. For example, the average coefficient of friction for the belt may be reduced about 50-100%.

Moreover, the present disclosure has recognized that one may apply a lubricant at the nip location between the aforementioned belts and the cleaning blade which therefore provides a method of maintaining lubrication as between the cleaning blade and belt over the life of the belt within a given printer. For example, lubrication may be provided over tens of thousands of printing cycles. In such regard, in one operating example, the lubricant described herein (Surelube 2SA™) was applied to a urethane blade which was then configured to form a nip with an ETFE belt. Such configuration was then evaluated and found to operate over a continuous 72 hour period without stalling or flipping, as noted above.

Furthermore, it has also been recognized that the lubrication disclosed herein may completely avoid the need to otherwise ensure the presence of some amount of toner across the entire nip, which toner otherwise acts as a lubricating substance. That is, by lubricating the entire nip location herein, lubrication is ensured to be present at those regions of the nip which would not otherwise see toner thereby making it relatively easier to clean those corresponding portions of the belt where toner particulate is absent. In that sense the present disclosure offers yet another advantage over those systems, described above, that may rely upon toner as the lubricant during printer operation.

The foregoing description of several methods and an embodiment of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for removing contaminants from a belt in an electrophotographic printer comprising
providing a blade having a surface for contact with said belt surface and forming a nip having a first coefficient of friction (COF₁), wherein said belt surface is configured to:
(a) receive a toner image for transfer to a sheet of media; or
(b) transport media within the printer for receipt of a toner image;
applying a lubricant to said blade surface and forming a coating, said lubricant comprising a fluoropolymer resin in combination with a polymeric binder, said coating having a thickness of 1-30 microns, wherein said coated blade surface forms a nip with said belt surface and providing a second coefficient of friction (COF₂), wherein COF₂<COF₁.

2. The method of claim 1, wherein a percent reduction of COF₂ relative to COF₁ is at least 50%.

3. The method of claim 1 wherein said coating has a thickness of 5-20 microns.

4. The method of claim 1 wherein said belt surface contains charged toner and said binder resin is capable of providing charge dissipation to said charged toner.

5. The method of claim 1 wherein said binder component is a polyamine type polymer of the following structure: 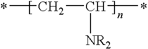
where R may be an aliphatic, cycloaliphatic, substituted aliphatic and/or aromatic type functionality.

6. The method of claim 1 wherein said binder component comprises poly(vinyl pyrrolidone) having the following structure:

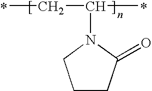

7. The method of claim 1 wherein said blade is formed from a polyurethane material.

8. The method of claim 1, wherein said toner image that is received on said belt or received on said media comprises toner prepared by a chemical methods.

9. The method of claim 1 wherein said method is carried out in a laser printer.

10. The method of claim 1 wherein said method is carried out in a printer cartridge.

11. A printer including a belt having a surface, comprising:
a blade having a surface configured to contact with said belt surface to form a nip with said belt surface, wherein said nip defines a first coefficient of friction (COF₁) as between said blade surface and said belt, wherein said belt surface is configured to:
(a) receive a toner image for transfer to a sheet of media; or
(b) transport media within the printer for receipt of a toner image;
wherein said blade surface includes a coating, said coating comprising a fluoropolymer resin in combination with a polymeric binder, said coating having a thickness of 1-30 microns, wherein said coated blade surface forming a nip with said belt surface provides a second coefficient of friction (COF₂), wherein COF₂<COF₁.

12. The printer of claim 11 wherein a percent reduction of COF₂ relative to COF₁ is at least 50%.

13. The printer of claim 1 wherein said coating has a thickness of 5-20 microns.

14. The printer of claim 1 wherein said belt surface contains charged toner and said binder resin is capable of providing charge dissipation to said charged toner.

15. The printer of claim 1 wherein said binder component is a polyamine type polymer of the following structure: 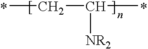
where R may be an aliphatic, cycloaliphatic, substituted aliphatic and/or aromatic type functionality.

16. The printer of claim 1 wherein said binder component comprise poly(vinyl pyrroilidone) having the following general structure:

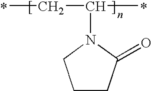

17. The printer of claim 1 wherein said blade is formed form a polyurethane material.

18. The printer of claim 1 wherein said toner image that is received on said belt or received on said media comprises toner prepared by chemical methods.

19. The printer of claim 1 wherein said printer is a laser printer.

20. A printer including a belt having a surface, comprising:
a blade having a surface configured to contact with said belt surface to form a nip with said belt surface, wherein said nip defines a first coefficient of friction (COF₁) as between said blade surface and said belt, wherein said belt surface is configured to:
(a) receive a toner image for transfer to a sheet of media; or
(b) transport media within the printer for receipt of a toner image;
wherein said blade surface includes a coating, said coating comprising a fluoropolymer resin in combination with a polymeric binder, said coating having a thickness of 1-30 microns, wherein said coated blade surface forming a nip with said belt surface provides a second coefficient of friction (COF₂), wherein the percent reduction of COF₁ relative to COF₂ is at least 50% and wherein said toner image that is received on said belt or received on said media comprises toner prepared by chemical methods.
